(19) United States
(12) Patent Application Publication
(10) Pub. No.: US 2009/0289861 A1
(43) Pub. Date: Nov. 26, 2009

(54) RADIO FREQUENCY COMMUNICATION DEVICES AND METHODS

(75) Inventors: Weimin Tang, Singapore (SG); Ern Tang Chu, Singapore (SG); Chao Li, Singapore (SG)

Correspondence Address: ESCHWEILER & ASSOCIATES LLC, 629 EUCLID AVENUE, SUITE 1000, NATIONAL CITY BUILDING, CLEVELAND, OH, 44114, US

(73) Assignee: Infineon Technologies AG, Neubiberg (DE)

(21) Appl. No.: 12/123,730

(22) Filed: May 20, 2008

(51) Int. Cl. H01Q 1/00

(52) U.S. Cl. 343/722

(57) ABSTRACT

One embodiment relates to a circuit for efficient wireless communication. The circuit includes an antenna feed and a plurality of communication paths stemming from the antenna feed, where different communication paths are associated with different frequency bands. The circuit also includes a shunt coupled to the antenna feed and adapted to selectively divert power from the antenna feed as a function of shunt control signal. Other methods and systems are also disclosed.

### FIELD OF DISCLOSURE

The present disclosure relates generally to methods and systems related to radio frequency (RF) communication devices.

### BACKGROUND

In emerging markets throughout the world, such as China and India, the rising middle and lower-middle classes are demanding affordable wireless service. To tap this huge market, wireless service providers are striving to provide affordable access services and handsets to these customers.

Consequently, engineers are continuously looking for ways to modify existing mobile phone architectures to achieve a lower cost design without giving up quality or desirable features.

### SUMMARY

The following presents a simplified summary. This summary is not an extensive overview, and is not intended to identify key or critical elements. Rather, the primary purpose of the summary is to present some concepts in a simplified form as a prelude to the more detailed description that is presented later.

One embodiment relates to a circuit for efficient wireless communication. The circuit includes an antenna feed and a plurality of communication paths stemming from the antenna feed, where different communication paths are associated with different frequency bands. The circuit also includes a shunt coupled to the antenna feed and adapted to selectively divert power from the antenna feed as a function of shunt control signal.

The following description and annexed drawings set forth in detail certain illustrative aspects and implementations. These are indicative of only a few of the various ways in which the principles disclosed may be employed.

### BRIEF DESCRIPTION OF THE DRAWINGS

FIG. 1 shows a transceiver portion of wireless communication device that includes an antenna switch module (ASM);

FIG. 2 shows a wireless communication device that may suffer from inadequate isolation between its transmission feed and reception feed;

FIG. 3 shows an embodiment of a wireless communication device that may provide improved isolation;

FIG. 4 shows an embodiment of a timing diagram that is discussed in the context of FIG. 3's wireless communication device;

FIG. 5-6 show more detailed embodiments of phase shift selection circuits;

FIGS. 7-8 show Smith charts illustrating one manner in which phase shift selection circuits can be designed; and

FIG. 9 shows a flow chart illustrating a method in flow chart format.

### DETAILED DESCRIPTION

One or more implementations will now be described with reference to the attached drawings, wherein like reference numerals are used to refer to like elements throughout. It will be appreciated that nothing in this specification is admitted as prior art.

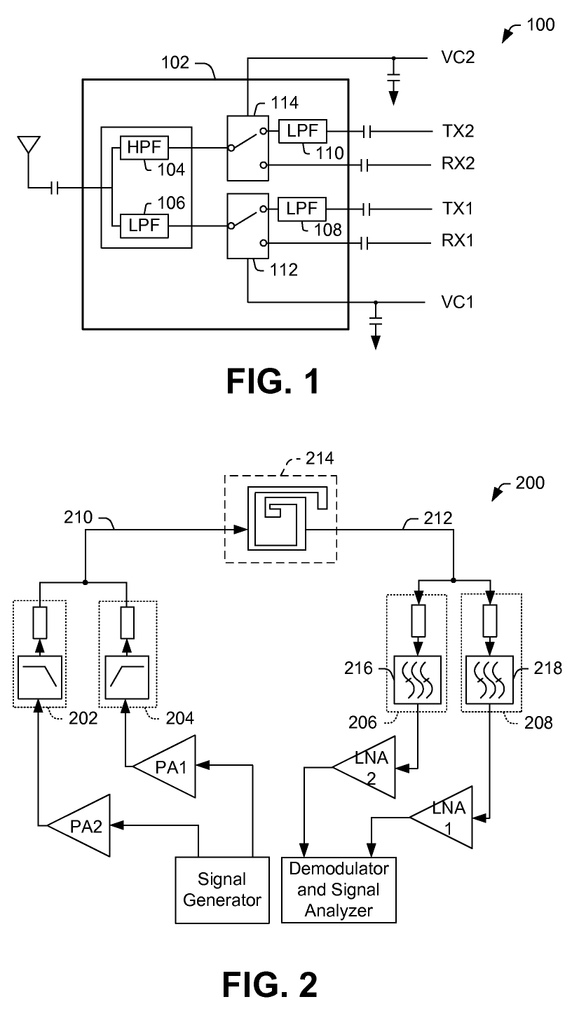

FIG. 1 shows an example of a GSM/DCS dual band cellular phone that includes a front-end 100 with an antenna switch module 102 (ASM). The ASM includes various filters (104, 106, 108, 110) and switches (112, 114) that allow it to effectively switch between transmit and receive frequency bands (TX1, TX2 and RX1, RX2). However, because each ASM costs up to $5 per piece, depending on the quantity purchased, the expense associated with the ASM 102 makes it unrealistic for low cost cell phone architectures. The ASM 102 is also responsible for unavoidable insertion loss, which may degrade RF performance (e.g., decrease receive sensitivity and transmit power).

FIG. 2 depicts a dual band analog front end 200 that eliminates the need for an ASM by including phase shift selection circuits (e.g., 202, 204, 206, 208). As will be described in more detailed further herein, these phase shift selection circuits act as switches in some respects, and are cheaper to implement than an ASM. Thus, this front end 200 will be more affordable relative to the previous front end 100, which included an ASM 102. Unfortunately, however, this front end 200 may suffer from a shortcoming due to leakage between the transmission feed 210 and the reception feed 212 over the antenna 214. Thus, power transmitted on transmission feed 210 may leak onto the reception feed 212, sometimes exceeding the power capacity of the reception phase shift selection circuits 206, 208. This excess power may damage the reception phase shift selection circuits 206, 208, absent countermeasures. For example, in one embodiment, GSM transmit power on transmission feed 210 can be as high as about 35 dBm, while the power capacity of SAW filters 216, 218 may be only about 15 dBm.

To limit the transmit power that reaches the reception phase shift selection circuits, the inventors have fashioned wireless communication devices that include transmission and reception shunts. During operation, these transmission and reception shunts selectively divert power from the reception feed and/or transmission feed, thereby isolating the transmission and reception feeds.

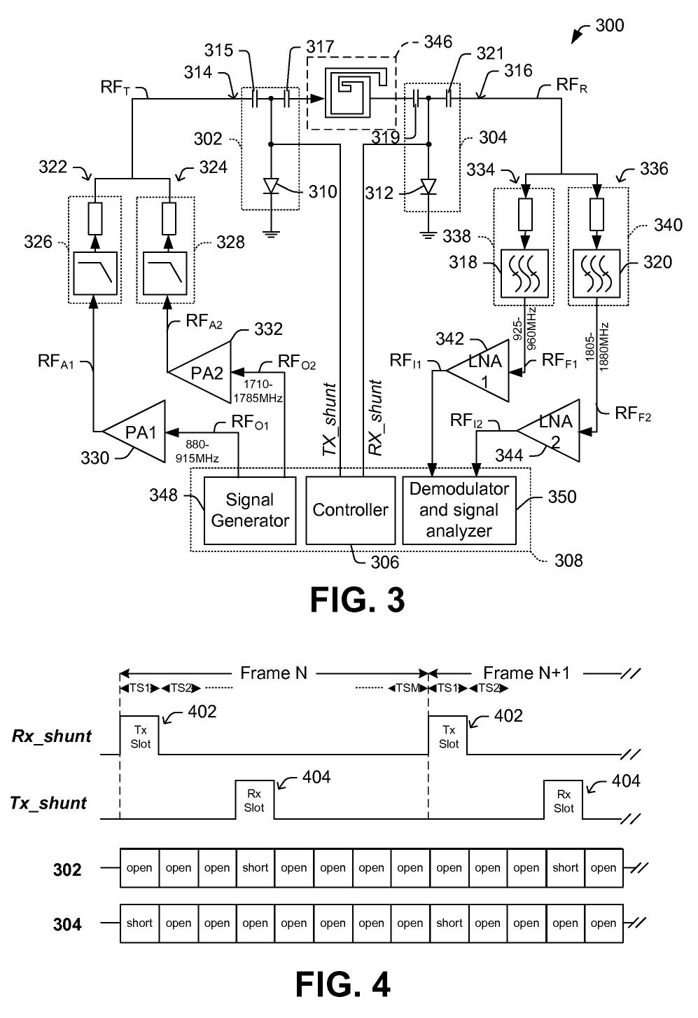

FIGS. 3-4 depict a wireless communication device 300 that includes a transmission shunt 302 and a reception shunt 304. To coordinate the desired functionality, a controller 306 (which can be part of a baseband processor 308 in some embodiments) provides control signals TX_shunt, RX_shunt to the transmission shunt 302 and reception shunt 304, respectively. Although the illustrated transmission and reception shunts 302, 304 comprise diodes 310, 312 respectively coupled to transmission and reception feeds 314, 316, in other embodiments the transmission and reception shunts 302, 304 could comprise other passive circuits (e.g., resistive loads) or active circuits (e.g., transistors or other switching elements). In addition, although this communication device 300 includes transmission and reception shunts 302, 304 it will be appreciated that in other embodiments only a transmission shunt 302 (or only a reception shunt 304) could be employed.

During operation, the communication device 300 is assigned to its own transmission time slot 402 and its own reception time slot 404 within a frame (FIG. 4). During the transmission time slot 402, the controller 306 asserts the signal RX_shunt and de-asserts the signal TX_shunt. In the illustrated embodiment, this assertion causes the diode 312 to be forward biased. Thus, if transmitted power leaks onto the reception feed 316, the leaked power will be diverted through the reception shunt 304 to ground (GND). In this way, there is sufficient isolation so the transmission feed 314 can carry a high power transmission signal, RF_{T}, without risking damage to SAW filters 318, 320. Conversely, during the reception time slot 404, the controller 306 asserts signal TX_shunt and de-asserts signal RX_shunt, which diverts leakage power from the transmission feed 314 through the transmission shunt 302 to GND. This will enable the antenna design feed-point to be symmetrical to the transmission mode.

In this manner, the shunts 302, 304 isolate the transmission feed 314 and reception feed 316 from one another. In addition, capacitors 315, 317, 319, 321 may also be present along the transmission and reception feeds 314, 316, where the capacitors are on opposing sides of the shunts. Moreover, as described in more detail below, individual communication paths that stem from the communication feeds 314, 316 are also isolated from one another by the use of phase shift selection circuits.

On the transmit side, a first transmission path 322 and a second transmission path 324 stem from the transmission feed 314 and deliver different respective frequency components to the transmission feed. The first and second transmission paths 322, 324 include first and second transmission phase shift selection circuits 326, 328 and first and second power amplifiers 330, 332, respectively.

On the receive-side, a first reception path 334 and a second reception path 336 stem from the reception feed 316 and separate out (filter) different respective frequency components from the reception feed. The first and second reception paths 334, 336 include first and second reception phase shift selection circuits 338, 340 and first and second low noise amplifiers 342, 344, respectively.

During transmission, the transmitted signal RF_{T}, which is provided to the dual feed antenna 346 via the transmission feed 314, can include frequency components falling within one of two transmission frequency bands. The first transmission path 322 provides a transmission signal over a first transmission frequency band, while the second transmission path 324 provides a transmission signal on a second transmission frequency band.

For example, when the signal generator 348 generates an outgoing signal RF_{O1} in the first transmission frequency band (e.g., ˜880-915 MHz), the first transmission phase shift selection circuit 326 is structured to represent an approximately matched impedance (e.g., about 50 ohms). Consequently, the first power amplifier 330 amplifies RF_{O1} to generate an amplified signal RF_{A1}. For RF_{A1}, the first transmission phase shift selection circuit 326 passes frequency components within the first transmission band with limited or no attenuation and suppresses the high frequency components generated by the first power amplifier 330. The second transmission phase shift selection circuit 328 is structured to represent a high or infinite impedance for the first transmission frequency band. Consequently, although RF_{A1} passes through the first transmission phase shift selection circuit 326, it will not leak through the second transmission phase shift selection circuit 328 and a vast majority of the power in RF_{A1} will be successfully transmitted to the dual feed antenna 346.

Conversely, in the second transmission frequency band (e.g., 1710-1785 MHz), the signal generator 348 generates an outgoing signal RF_{O2} on the second transmission path 324. The second power amplifier 332 then amplifies or modulates the signal RF_{O2}, thereby generating an amplified signal RF_{A2} that is passed to the second transmission phase shift selection circuit 328. Because the second transmission phase shift selection circuit 328 represents a matched impedance at the second transmission frequency band, RF_{A2} passes through with limited or no attenuation. The transmission phase shift selection circuit 328 will suppress other high frequency components generated by the second power amplifier 332. The frequency components passing through the second transmission phase shift selection circuit 328 will see a high impedance at the first transmission phase shift selection circuit 326, so power will not leak back through the first transmission phase shift selection circuit 326. In this way, the transmission frequency bands are isolation from one another.

The received signal RF_{R}, which is provided to the reception feed 316 from the dual feed antenna 346, can include practically any frequency component detected by the dual feed antenna 346. Therefore, the first reception path 334 separates out signal components within a first reception frequency band (e.g., about 925-960 MHz), while the second reception path 336 separates out signal components within a second reception frequency band (e.g., about 1805-1880 MHz). Consequently, only RF_{F1} passes through the first reception phase shift selection circuit 338 with limited or no attenuation. Conversely, only RF_{F2} passes through the second reception phase shift selection circuit 340 with limited or no attenuation. These filtered signals RF_{F1}, RF_{F2} are then amplified by low noise amplifiers 342, 344 to generate incoming signals RF_{I1}, RF_{I2}. The incoming signals are then demodulated and analyzed by the demodulator and signal analyzer 350, which can pass analyzed signals to a user interface (e.g., speaker, visual display, etc.).

Although the illustrated embodiment shows a dual-feed antenna 346 where two transmission paths 322, 324 and two reception paths 334, 336 stem from the respective communication feeds, in other embodiments more than two transmission paths could stem from the transmission feed 314 and more than two reception paths could stem from the reception feed 316. For example, in one embodiment of a quad-band phone, four transmission paths could stem from the transmission feed 314, and four reception paths could stem from the reception feed 316. In one embodiment, the dual-feed antenna 346 could be a planar inverted F antenna (PIFA), but could also be other types of antennas in other embodiments.

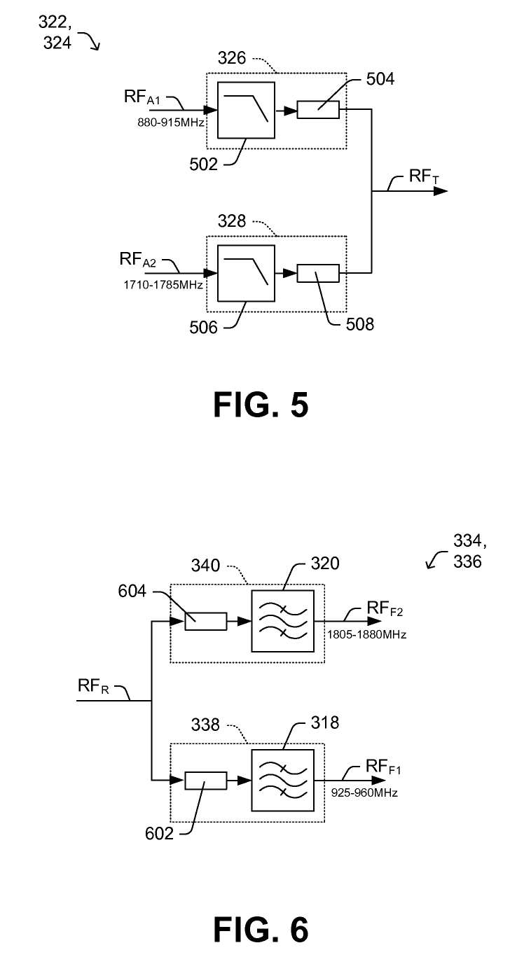

As shown in FIGS. 5-6, in some embodiments the phase shift selection circuits can comprise passive circuits. These passive circuits have different respective impedances that vary as a function of communication frequency. In FIG. 5's embodiment, the first transmission phase shift selection circuit 326 includes a low pass filter 502 and a phase shift matching filter 504. Similarly, the second transmission phase shift selection circuit 328 includes a low pass filter 506 and a phase shift matching filter 508. These low pass filters 502, 506 are used primarily for suppressing high frequency components generated by the power amplifiers 330, 332. The low pass filters 502, 506 work in conjunction with the phase shift matching filters 504, 508 to allow the desired transmission frequencies to pass, while blocking unwanted frequencies as previously discussed. In some embodiments, the phase shift matching filters 504, 508 can comprise microstrip lines that have different lengths or geometries on each path.

In FIG. 6, one can see an embodiment where the first reception phase shift selection circuit 338 includes a phase shift matching filter 602 and a surface acoustic wave (SAW) filter 318. Similarly, the second reception phase shift selection circuit 340 includes a phase shift matching filter 604 and a surface acoustic wave (SAW) filter 320. These phase shift matching filters 602, 604 and SAW filters 318, 320 are tuned to allow the desired reception frequencies to pass, while blocking unwanted frequencies as previously discussed. Again, in some embodiments, the phase shift matching filters 602, 604 can comprise microstrip lines that have different lengths or geometries on each path. Thus, the combination of SAW filters and microstrip lines can function as a diplexer in the receiver path.

In some embodiments, the power supply capacity of each SAW filter 318, 320 is about 15 dBm, whereas a transmit power of about 35 dBm can be presented at the transmission feed 314. As a result, about 20 dB of isolation between the transmission feed 314 and reception feed 316 may be desirable.

This will prevent damage to the SAW filters 318, 320 and will prevent performance degradation due to too much power at the LNA input ports.

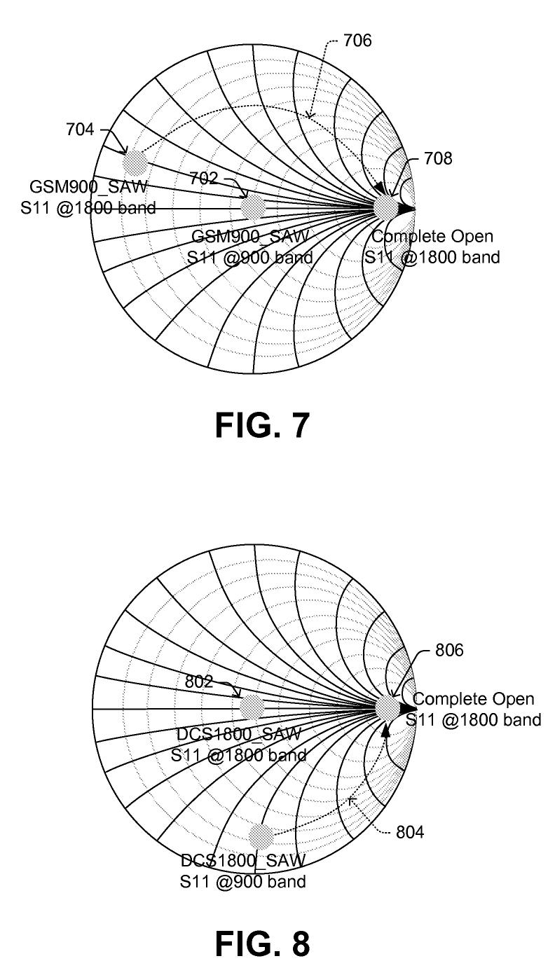

FIGS. 7-8 show more detailed embodiments of Smith charts illustrating one manner in which the matching can be accomplished on the receive-side. More specifically, FIG. 7 shows functionality of the first reception phase selection circuit 338 for different frequencies. At 702, which relates to 900 MHz received signals, the S parameter of the SAW filter 318 approximates a closed switch and has a matched impedance of approximately 50 ohms (little or no attenuation). For signals received at 1800 MHz, the SAW filter alone 704 still represents a near zero impedance, so the microstrip line 602 is included to provide a phase shift 706. This phase shift causes a significantly increased impedance for the first reception phase shift selection circuit 338 at 1800 MHz (708). In this way, the first reception phase shift selection circuit 338 allows low GSM frequencies to pass, and at the same time blocks DCS frequencies.

FIG. 8 shows the S parameter of the second reception phase shift selection circuit 340 for different frequencies. At 802, which relates to 1800 MHz received signals, the SAW filter 320 approximates a closed switch having a matched impedance of approximately 50 ohms. At 900 MHz, however, the microstrip line 604 provides phase shifting 804 so the second reception phase shift selection circuit 340 will represent an infinite or very high impedance 806.

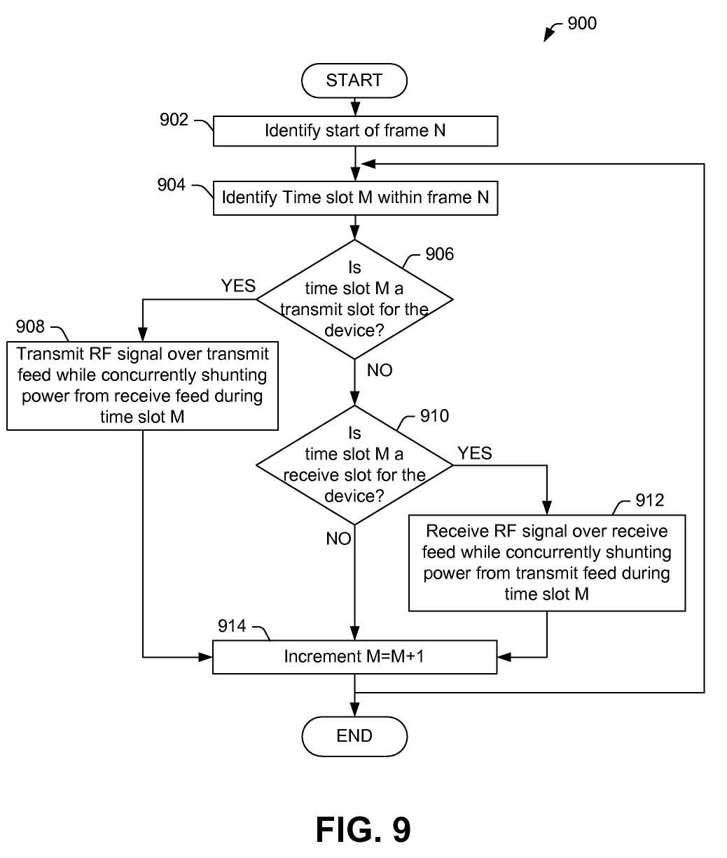

Now that some examples of systems have been discussed, reference is made to FIG. 9, which shows a method 900 in flowchart format. While this method is illustrated and described below as a series of acts or events, the present invention is not limited by the illustrated ordering of such acts or events. For example, some acts may occur in different orders and/or concurrently with other acts or events apart from those illustrated and/or described herein. In addition, not all illustrated acts may be required. Further, one or more of the acts depicted herein may be carried out in one or more separate acts or phases.

At 902, the wireless communication device identifies the start of frame N. At 904, the wireless communication device identifies a time slot M within the frame N.

At 906, a determination is made whether the time slot M is a transmit slot that is reserved for the wireless communication device. If so (“YES”) at 906, a signal RF_{T} is transmitted over an antenna via a transmission feed. During transmission during time slot M, power is concurrently shunted from the reception feed of the antenna.

If the time slot M is not a transmission slot for the wireless communication device (“NO” at 906), the method proceeds to 910. In 910, a determination is made whether the time slot M is a receive slot reserved for the wireless communication device. If so (“YES” at 910), the method proceeds to 912, and an signal RF_{R} is received over the receive feed. While the signal RF_{R} is received during timeslot M, power is concurrently shunted from the transmission feed to incorporate a symmetrical antenna design with the transmission mode. In this way, isolation is achieved between the transmission feed and reception feed.

After time slot M is carried out, the method can evaluate other timeslots and other frames in a similar manner (e.g., 914).

Although one or more implementations has been illustrated and/or discussed above, alterations and/or modifications may be made to these examples without departing from the spirit and scope of the appended claims. For example, although some embodiments describe a wireless communication device as a cellular phone, in other embodiments the wireless communication device could be another type of communication device, including but not limited to: a personal digital assistant, a pager, a walkie-talkie, a music device, a laptop, etc.

Some methods and corresponding features of the present disclosure can be performed by hardware modules, software routines, or a combination of hardware and software. To the extent that software is employed, for example by a baseband processor or other processor associated with the radar system, the software may be provided via a “computer readable medium”, which includes any medium that participates in providing instructions to the processor. Such a computer readable medium may take numerous forms, including but not limited to, non-volatile media, volatile media, and transmission media. Non-volatile media includes, for example, optical disks (such as CDs, DVDs, etc.) or magnetic disks (such as floppy disks, tapes, etc.). Volatile media includes dynamic memory, such as ferroelectric memory, SRAM, or DRAM. Transmission media includes coaxial cables, copper wire, fiber optics, etc. that could deliver the instructions over a network or between communication devices. Transmission media can also include electromagnetic waves, such as a voltage wave, light wave, or radio wave.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A circuit for efficient wireless communication, comprising:
an antenna feed;
a plurality of communication paths stemming from the antenna feed, where different communication paths are associated with different frequency bands; and
a shunt coupled to the antenna feed and adapted to selectively divert power from the antenna feed as a function of shunt control signal.

2. The circuit of claim 1, wherein the shunt control signal is selectively asserted or de-asserted based on whether a radio frequency signal is to be transmitted or received over the antenna feed.

3. The circuit of claim 1, where the shunt comprises a diode.

4. The circuit of claim 1, where the shunt comprises a transistor.

5. The circuit of claim 1, further comprising:
a plurality of phase shift selection circuits respectively associated with the plurality of communication paths, where the phase shift selection circuits represent different respective impedances for the different frequency bands.

6. A radio frequency (RF) communication device, comprising:
an antenna adapted to be coupled to a transmission feed and a reception feed;
a plurality of transmission paths stemming from the transmission feed, where different transmission paths are associated with different transmission frequency bands;
a plurality of reception paths stemming from the reception feed, where different reception paths are associated with different reception frequency bands; and
a reception shunt coupled to the reception feed and adapted to selectively divert power from the reception feed during a transmission time slot when data is to be transmitted over the antenna.

7. The RF communication device of claim 6, further comprising:
a transmission shunt coupled to the transmission feed and adapted to selectively divert power from the transmission feed during a reception time slot when data is to be received over the antenna.

8. The RF communication device of claim 6, further comprising:
a plurality of transmission phase shift selection circuits that are respectively associated with the transmission paths, where the transmission phase selection circuits represent different impedances for the different transmission frequency bands.

9. The RF communication device of claim 8, where a transmission phase shift selection circuit comprises:
a low pass filter adapted to pass a transmission frequency band associated with a transmission path; and
a microstrip line between the low pass filter and the transmission feed.

10. The RF communication device of claim 8, further comprising:
a plurality of power amplifiers respectively associated with the plurality of transmission paths, where a power amplifier is adapted to provide an amplified signal to a transmission phase shift selection circuit.

11. The RF communication device of claim 8 further comprising:
a plurality of reception paths stemming from the reception feed, where different reception paths are associated with different reception frequency bands; and
a plurality of reception phase shift selection circuits respectively associated with the plurality of reception paths, where the reception phase shift selection circuits provide different respective impedances relative to the reception feed for the different reception frequency bands.

12. The RF communication device of claim 6, where the antenna comprises a planar inverted F antenna.

13. A method for efficient wireless communication, comprising:
transmitting a radio frequency transmission signal over a transmission feed of an antenna during a transmission time slot; and
shunting power from a reception feed of the antenna during the transmission time slot.

14. The method of claim 13, where the antenna comprises a dual-feed or multi-feed antenna.

15. The method of claim 13, where at least about 20 dB of isolation separates the transmission feed from the reception feed.

16. The method of claim 13, further comprising:
receiving a radio frequency reception signal via the reception feed during a reception time slot; and
shunting power from the transmission feed during the reception time slot.

17. The method of claim 16, where receiving the reception signal comprises;
providing the reception signal to different reception paths stemming from the reception feed; and
isolating different desired frequency components along the respective different reception paths by phase shifting and filtering the reception signal by different respective amounts for the different reception paths.

18. The method of claim 17, where receiving the reception signal further comprises:
amplifying the filtered and phase shifted signals to generate respective incoming signals, where the respective incoming signals have different desired frequency components.

19. The method of claim 18, where receiving the reception signal further comprises:
de-modulating and analyzing the respective incoming signals for presentation via a user interface.

20. The method of claim 13, where transmitting the transmission signal comprises:
generating an outgoing signal having a transmission frequency, where the outgoing signal is transmitted along one of a number of transmission paths that is associated with the transmission frequency;
amplifying the outgoing signal to generate an amplified signal;
generating a transmission signal by filtering and phase shifting the amplified signal; and
providing the transmission signal to the transmission feed for transmission via the antenna.

21. A method for efficient wireless communication over an antenna associated with at least one transmission feed and at least one reception feed, comprising:
identifying a reception time slot within a frame;
during the reception time slot, receiving over the antenna a reception signal that includes frequency components of a first reception frequency band and a second frequency band; and
providing the reception signal along the reception feed and concurrently shunting power from the transmission feed.

22. The method of claim 21, further comprising:
identifying a transmission time slot within the frame;
during the transmission time slot, providing a transmission signal that includes frequency components of a first transmission frequency band along the transmission feed and concurrently shunting power from the reception feed.

23. The method of claim 22, further comprising;
providing the reception signal to first and second reception paths stemming from the reception feed; and
isolating frequency components of the first reception frequency band along the first reception path by phase shifting by a first amount; and
isolating the frequency components of the second reception frequency band along the second reception path by phase shifting by a second amount that differs from the first amount.

24. A radio frequency (RF) communication device, comprising:
an antenna adapted to be coupled to a transmission feed and a reception feed;
means for selectively diverting power from the transmission feed during a reception time slot in which a reception radio frequency signal is to be received over the reception feed; and
means for selectively diverting power from the reception feed during a transmission time slot in which a transmission radio frequency signal is to be transmitted over the transmission feed.
